(19) United States
(12) Patent Application Publication
(10) Pub. No.: US 2010/0162407 A1
(43) Pub. Date: Jun. 24, 2010

(54) APPARATUS, METHOD, AND RECORDING MEDIUM

(75) Inventor: Yasuhiro Hosoda, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/623,313

(22) Filed: Nov. 20, 2009

(30) Foreign Application Priority Data
Dec. 18, 2008 (JP) 2008-322584

(51) Int. Cl. G06F 9/445; G06F 13/00; G06F 3/048; G06F 21/00; G06F 9/46

(52) U.S. Cl. 726/26; 710/33; 717/174; 715/764; 718/100

(57) ABSTRACT

It requires a lot of money to newly develop a management application operating on an apparatus or an information device for managing the function of the multifunction peripheral from a remote place. To a management apparatus already existing in the market, information including function information which is not an object of management of the management apparatus requested by the management apparatus is returned in a format interpretable for the management apparatus. Further, a function of an apparatus which is not an object of management of the management apparatus is managed by carrying out processing which is not a processing requested by the management apparatus.

### BACKGROUND OF THE INVENTION

1. Field of the Invention

The present invention relates to an apparatus, a method, and a recording medium performing validation/invalidation and activation/termination of a function by receiving of an external request in the apparatus provided with a plurality of functions.

2. Description of the Related Art

A recent multifunction peripheral accommodating a network is provided with many optional functions such as an external transmission function of a scanned document, a department management function counting the number of use for each department, and an electric power saving mode, in addition to the functions of copy, print, fax, etc. Among these options, some functions themselves are provided at the time of factory shipment but are activated only when a user buys licenses separately and inputs license keys into the multifunction peripheral.

Further, there has been proposed so far a multifunction peripheral which can install and uninstall an application (Japanese Patent Laid-Open No. 2002-287990). For a technique decreasing the burden of installing an application into an individual multifunction peripheral, there has been proposed an apparatus installing software into a plurality of computers from a remote place (Japanese Patent Laid-Open No. H06-12348 (1994)) .

Moreover, Japanese Patent Laid-Open No.H11-225240 (1999), for example, proposes a multifunction peripheral in which inquiry of a job status and cancel of the job can be performed from a remote place.

Some functions recently provided to the multifunction peripheral at the time of product shipment need different management methods depending on the functions, and for example, the functions for which function setting from a remote place is available and ones for which function setting from a remote place is not available are mixed. In addition, even if the function setting from the remote place is available, each of communication protocols for the setting could be different from another depending on the functions. Further, a new function is provided to every new multifunction peripheral, and it is desirable that these functions can be set from a remote place. Considering the above, there is a problem in which it needs a cost in order to newly develop an information device for managing the function of the multi function peripheral from a remote place and a management application operating on information equipments.

The present invention provides an apparatus, a method and a recording medium which realize a way for managing a function mounted at the time of factory shipment by using a management apparatus or a management application which is already available in the market.

### SUMMARY OF THE INVENTION

An apparatus according to the present invention that can communicate with an external apparatus, includes: a receiving unit receiving an obtaining request of information about a function included in the apparatus from the external apparatus; and a transmission unit transmitting information about a function different from the function related to the obtaining request to the external apparatus in response to the obtaining request received by the receiving unit.

The present invention can provide an apparatus, a method and a recording medium which realize a way for managing a function mounted at the time of factory shipment by using an application management apparatus or a job management apparatus for an apparatus already existing in the market.

Further features of the present invention will become apparent from the following description of exemplary embodiments (with reference to the attached drawings).

### BRIEF DESCRIPTION OF THE DRAWINGS

FIG. 1 is a schematic diagram showing a configuration of an image forming apparatus in embodiment 1 and embodiment 2;

FIG. 2 is a schematic diagram showing a configuration of a network in embodiment 1 and embodiment 2;

FIG. 3 is a diagram showing an application management screen for an image forming apparatus in a management apparatus 200;

FIG. 4 is a diagram showing an application file configuration;

FIG. 5 is a diagram showing a license file configuration;

FIG. 6 is a flowchart showing the operation of an image forming apparatus at the time of receiving a request for obtaining an application information;

FIG. 7 is a diagram showing application information to be transmitted from an image forming apparatus to a management apparatus;

FIG. 8 is a diagram showing an application management screen of a management apparatus 200 after receiving of application information including main body function information;

FIG. 9 is a diagram showing a main body function license key input screen to be displayed on a user interface of an image forming apparatus;

FIG. 10 is a flowchart representing the operation of obtaining document transmission function information in a platform section;

FIG. 11 is a diagram showing a device setting menu screen (when a department management function is masked) to be displayed on a user interface of an image forming apparatus;

FIG. 12 is a flowchart representing the operation of obtaining power saving mode function information in a platform section;

FIG. 13 is a diagram showing a device reactivation screen to be displayed on a user interface of an image forming apparatus;

FIG. 14 is a diagram showing a device setting menu screen (after a department management function is visualized) to be displayed on a user interface of an image forming apparatus;

FIG. 15 is a flowchart representing the operation of obtaining department management function information in a platform section;

FIG. 16 is a flowchart showing the operation of an image forming apparatus at the time of receiving an application install request;

FIG. 17 is a flowchart showing the operation of an image forming apparatus at the time of receiving an application uninstall request;

FIG. 18 is a flowchart showing the operation of an image forming apparatus at the time of receiving a license install request;

FIG. 19 is a flowchart showing the operation of an image forming apparatus at the time of receiving an application activation request;

FIG. 20 is a flowchart showing the operation of an image forming apparatus at the time of receiving an application termination request;

FIG. 21 is a diagram showing a job management screen for an image forming apparatus in a management apparatus 200;

FIG. 22 is a flowchart showing the operation of an image forming apparatus at the time of receiving a print job list information obtaining request;

FIG. 23 is a flowchart showing the operation of an image forming apparatus at the time of receiving a scan job list information obtaining request;

FIG. 24 is a diagram showing print job list information to be transmitted from an image forming apparatus to a management apparatus 200;

FIG. 25 is a diagram showing scan job list information to be transmitted from an image forming apparatus to a management apparatus 200;

FIG. 26 is a diagram showing a job management screen for an image forming apparatus in a management apparatus 200 after receiving job list information including main body function information;

FIG. 27 is a flowchart showing the operation of an image forming apparatus at the time of receiving a print job cancel request;

FIG. 28 is a flowchart showing the operation of an image forming apparatus at the time of receiving a scan job cancel request; and

FIG. 29 is a schematic diagram of a network configuration in embodiment 3.

### DESCRIPTION OF THE EMBODIMENTS

Hereinafter, the best mode for implementing the present invention will be explained by using the drawings. Note that this explanation is exemplary and the scope of the invention is not limited to the present embodiments.

### First Embodiment

### Explanation of an Image Forming Apparatus 1

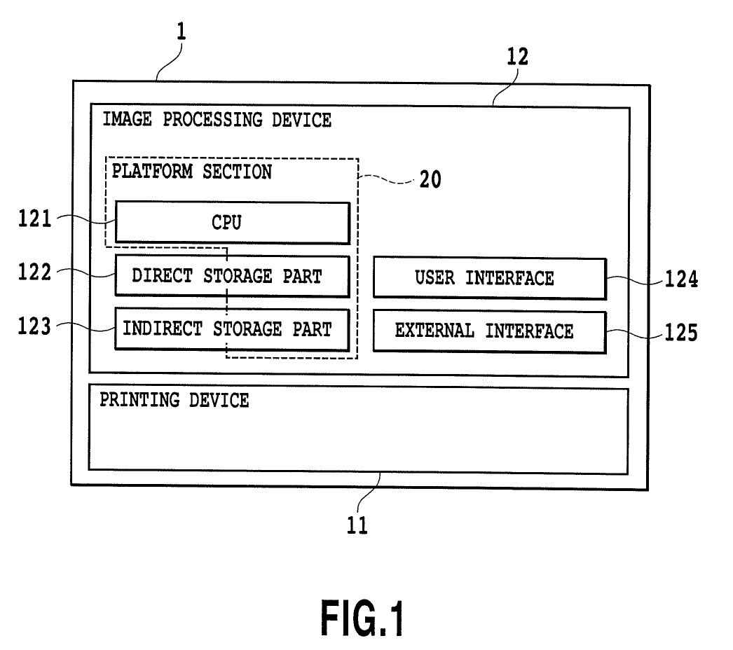

FIG. 1 is a block diagram showing a configuration of an image forming apparatus as an example of an apparatus according to one embodiment of the present invention.

The image forming apparatus 1 includes a printing device 11 and an image processing device 12.

The image processing device 12 includes a CPU 121, a direct storage part 122 (e.g., RAM), an indirect storage part 123 (e.g., ROM or HDD), a user interface 124, an external interface 125, and the like.

The direct storage part 122 is a storage part directly exchanging data with the CPU 121, and the indirect storage part 123 is a storage part exchanging data with the CPU 121 via the direct storage part 122.

The direct storage part 122 stores various application (software) programs and platform programs.

The user interface 124 includes a key board, a mouse, a display (operation part and display part), and the like, and is configured to be able to receive an instruction from a user and to display data (screen data).

The external interface 125 is configured to be able to receive data from an external apparatus and to transmit data to the external apparatus. For example, the external apparatus includes an external storage unit such as an external HDD and an external USB memory, and a separate apparatus such as a separate host computer and image forming apparatus connected via a network.

### [Explanation of a Platform Section 20]

The CPU 121 can move (store) the platform program stored in the indirect storage part 123 into the direct storage part 122. When the movement has been completed, the CPU 121 goes into a state of being able to execute the platform program.

In the present embodiment, such operation “the CPU 121 goes into a state of being able to execute the platform program” is referred to as an activation of a platform section 20.

Note that the following combination is referred to as the platform section 20 in the present embodiment. That is, a combination of the CPU 121, an area storing the platform program in the direct storage part 122, and an area (in the direct storage part 122 and the indirect storage part 123) storing information (computation result or the like) obtained when the CPU 121 has processed the above platform program.

### [Explanation of an Application Program]

The platform section 20 can move (store) a first application program stored in the indirect storage part 123 into the direct storage part 122. When the movement has been completed, the platform section 20 goes into a state of being able to execute the first application program. In the present embodiment, this is referred to as “the platform section 20 activates the first application program”.

Adversely, the platform section 20 can delete the first application program stored in the direct storage part 122 from the direct storage part 122. In the present embodiment, this is referred to as “the platform section 20 terminates the first application program”.

The platform section 20 can receive the data of the first application program via the external interface part 125 and store the data. At this time, the platform section 20 stores the existence of the first application program and puts the first application program under the management thereof. In the present embodiment, this is referred to as “an installation of the first application program into the platform section 20”.

Adversely, the platform section 20 can delete the first application program stored in the indirect storage part 123 (included in the platform section 20) from the indirect storage part 123. In the present embodiment, this is referred to as “the platform section 20 uninstalls the first application program from”. Note that, in the case of the first application program being activating when uninstalling the first application program, the platform section 20 carries out the uninstalling after terminating the program.

The platform section 20 can manage the license (license approval information) of the first application program. The license includes a usable period of times and a usable number of times, and the platform section 20 limits the activation of the application so that the application is not used, which does not have the license or is exceeding the usable period of times or the usable number of times. The platform section 20 can receive the license of the first application via the external interface part 125 and store the license of the first application into the indirect storage part 123 in relation to the application. In the present embodiment, this is referred to as “an installation of the license of the first application program into the platform section 20”.

In addition, although the above explanation has been made by taking the first application program as an example, it will be apparent to those skilled in the art that the explanation applies to another application program (e.g., second application program) in the same way.

The platform section 20 receives, interprets, and executes requests of the application install/uninstall, the activation/termination of the installed application, the license install, and inquiry about the information of the installed application, transmitted from the outside via the external interface 125.

The platform section 20 is provided with some functions at the time of product shipment. For example, these functions include a power saving function, a department management function, a document external transmission function, a device reactivation function, etc.

These functions are executed in collaboration with the platform section 20 and a hardware section. Hereinafter, the function provided to the platform section 20 at the time of product shipment is collectively referred to as “a main body function”. The main body function is a function included in the image forming apparatus and is not installed or uninstalled by a general user after the shipment of the image forming apparatus. The platform section 20 can carry out activation, termination, setting change, etc. of the main body function. The platform section 20 manages each main body function in association with a main body function ID. For example, the power saving function, the department management function, the document external transmission function, the device reactivation function, and a device power supply are associated with respective main body function IDs. Note that the application can be said to be a kind of the function because the application also realizes a kind of the function in collaboration with the platform 20 and the hardware section. In the present embodiment, the application is referred to as “a separate body function” for expressing a difference between the main body function and the application.

The platform section 20 can display or undisplay information indicating existence of the main body function on the user interface 124. In the present embodiment, this is referred to as visualization (displaying) of the function in the platform section 20 or devisualization (undisplaying) of the function in the platform section 20. Further, the devisualized state of the function is referred to as masking of the function. That is, the function is in an operable state via the user interface 124 when being in the visualized state, and the function is in an inoperable state via the user interface 124 when being in the devisualized state.

The platform section 20 receives the license of the main body function via the external interface 125 and makes the main body function go into an usable status. In the present embodiment, this is referred to as “the platform section 20 validates the main body function”.

### [Explanation of a Network Configuration]

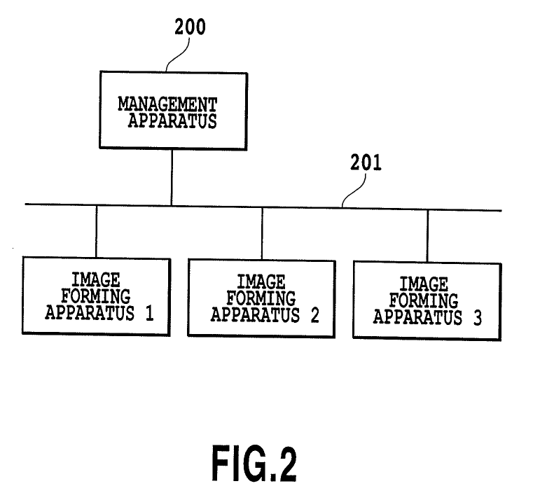

FIG. 2 is a schematic diagram showing a network configuration in the present embodiment. A management apparatus 200 has a function of managing the application installed in the image forming apparatus such as the image forming apparatus 1, 2, 3, or the like. The management apparatus 200 can manage the application that can be installed into the plurality of image forming apparatuses with which the management apparatus 200 can communicate via a network 201. The management apparatus 200 is configured with a general information processing apparatus such as a PC (Personal Computer), for example, and PC applications. A manager of the image forming apparatus can manage validation/invalidation, activation/termination, install/uninstall, etc. for the application of the image forming apparatus connected to the network, by operating a UI screen on the management apparatus 200. The management apparatus 200 is a management apparatus configured by an existing known technique.

### [Explanation of a Management UI on a PC]

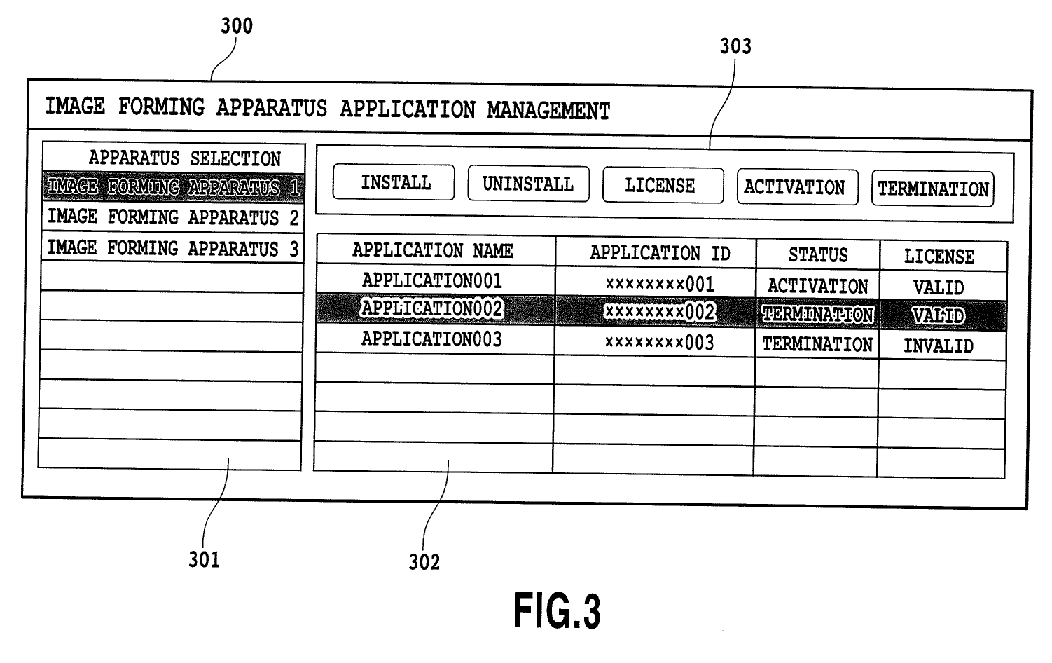

FIG. 3 is a diagram showing the UI screen displayed on the management apparatus 200 for managing the application of the image forming apparatus. On the application management screen 300 for the image forming apparatus are arranged an image forming apparatus selection view 301, an information display view 302 for the application installed in the selected image forming apparatus, and an application operation button group 303. The application information display view 302 displays an application name, an ID for uniquely specifying the application, an application status such as activation/termination, a status of the license, etc. The management apparatus 200 can transmit a request of obtaining information or the like to be displayed on the application information display view 302 to the selected image forming apparatus. Further, the management apparatus 200 carries out the following processing, for example, for the selected image forming apparatus in response to a user pushing down the application operation button.

Install button: Transmitting an application install request together with an application file

Uninstall button: Transmitting an uninstall request together with an application ID of the selected application

License button: Transmitting license install (license update) request together with a license file of the selected application

Activation button: Transmitting an activation request together with the application ID of the selected application

Termination button: Transmitting a termination request together with the application ID of the selected application

### [Explanation of an Application File Format]

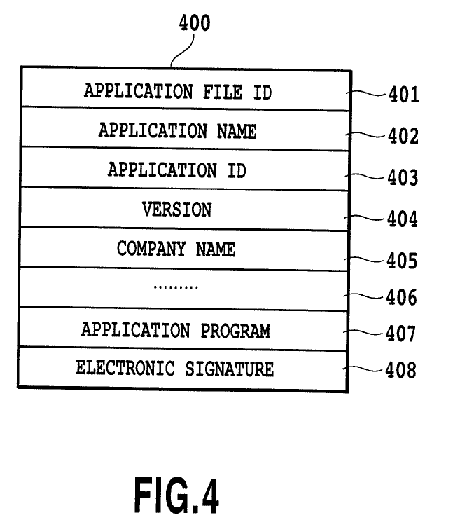

FIG. 4 is a schematic diagram showing a file format of the above application file (software format file). The application file 400 is configured with one or more files. Any of the files configuring the application file 400 include the following, for example: an application file ID 401 uniquely identifying the application file, an application name 402, an application ID 403 uniquely identifying the application, an application version 404, a company name 405 indicating a company which produced the application, an application program 407 operating on the image forming apparatus, an electronic signature 408 indicating that the application file 400 is a legitimate application, or an extension area 409 in which an application creator stores optional information.

### [Explanation of a License File Format]

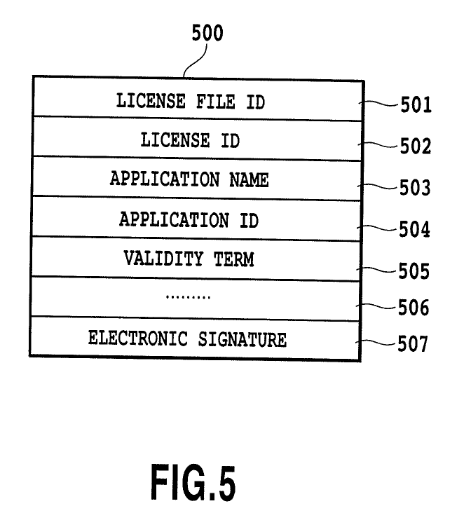

FIG. 5 is a schematic diagram showing a format of the above license file (license format file). The license file 500 is configured with one or more files. Any of the files configuring the license file 500 include the following, for example: a license file ID 501 uniquely identifying the file; a license ID 502 uniquely identifying the license; an application name 503 indicating the application of the license; an application ID 504; a license validity term 505; an electronic signature 507 indicating that the license file 500 is a legitimate application; or an extension area 506 storing encrypted confidential data and optional information.

[Explanation of Operation when the Image Forming Apparatus has Received an Application Information Obtaining Request]

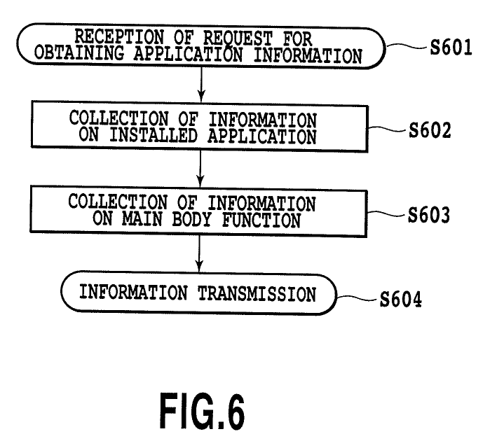

Next, operation will be explained with reference to the flowchart of FIG. 6 for the case in which any of the image forming apparatuses 1 managed by the management apparatus 200 has received a request for obtaining an application information from the management apparatus 200. The platform section 20 starts the operation in response to receiving a request for obtaining the application information from the management apparatus 200 via the external interface part 125 (S601). The platform section 20 collects application information of an installed application under the management thereof (application name, application ID, status, and license status) (S602). Next, the platform section 20 collects plural sets of main body function information (S603). The platform section 20 puts together the information sets collected in S602 and S603 and transmits the information to the management apparatus 200 (S604). In this manner in the present embodiment, when information obtaining is requested for the application, not only the information about the application but also the information about the main body function (this information includes the main body status such as activation/termination) is transmitted together. Note that the application is also a kind of the function in the same way as the main body function. Accordingly, in these steps S601, S603, and S604, when the information obtaining is requested for the application realizing a kind of the function, the information about the main body function realizing another kind of the function is also transmitted together with the information of the above application. Note that the information about the application includes the status such as activation/termination of the application, and the information about the main body function includes the status such as activation/termination of the main body function.

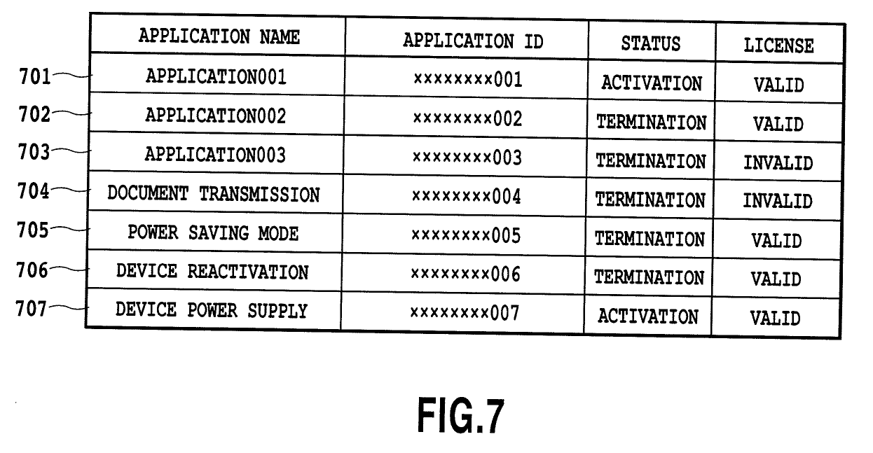

An example of the information transmitted to the management apparatus 200 will be explained with reference to FIG. 7. Application001 (701), Application002 (702), and Application003 (703) are information collected in S602 about the applications installed in the image forming apparatus 1. Document transmission (704), Power saving mode (705), Device reactivation (706), and Device power supply (707) are main body function information collected in S603. The main body function is set by associating the application information with a format for the transmission as shown below, for example.

Application name: Function name of each main body function

Application ID: Main body function ID

Status: Status matching the status of each main body function

License: Status matching the license status of each main body function

Such association with each other is carried out by the control of the platform section 20 based on a control program stored in the indirect storage part 123 or the like, or based on a user instruction input into the user interface 124.

As described above, the present embodiment carries out the association of the information (e.g., format) between the different functions (e.g., application and main body function) with each other. By carrying out the association of the information with each other in this manner, the image forming apparatus 1 can transmit the information about the main body function to the management apparatus 200 together with the information about the application, in the operation when having received the above described application information obtaining request.

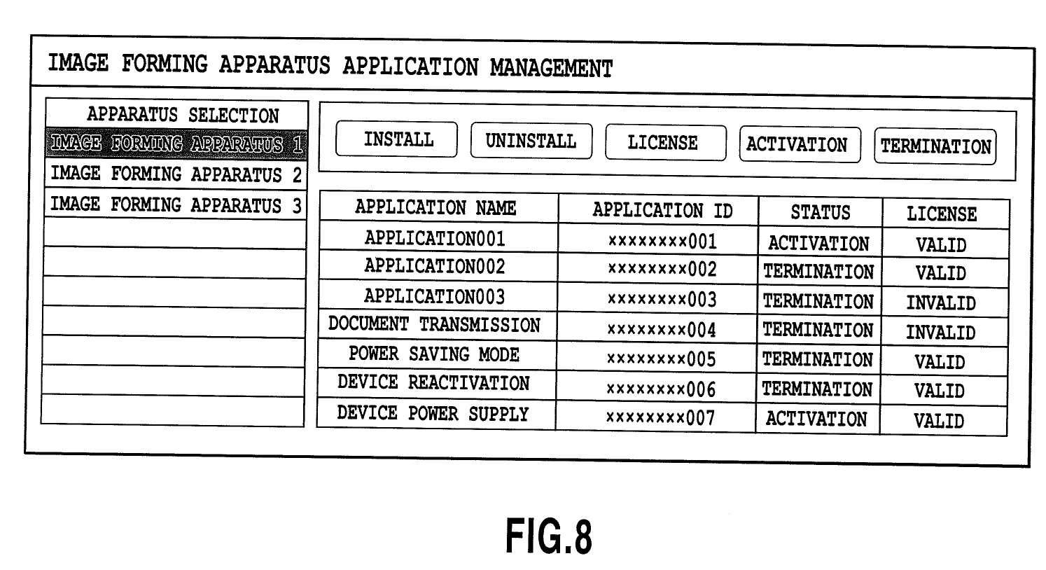

The management apparatus 200, which has received the information as shown in FIG. 7 from the image forming apparatus 1, displays the received information on the application information display view of the UI screen on the management apparatus (FIG. 8). That is, the management apparatus 200, even when having received the information about a function which is not the application function (e.g., main body function), can display the information on the UI screen for the application management and manage the information. As a result, the management apparatus 200 can manage the function included in the image forming apparatus 1, even when the management apparatus 200 is not provided with another configuration for managing the function which is not the application function.

A method of the information collection for the main body function in S603 is sometimes different depending on the main body function. An example of a detailed flow of the information obtaining for each of the main body function will be explained below.

### [Example of Obtaining Document Transmission Function Information]

The Document transmission (704) function, which is a kind of the main body function, is assumed to have the following property.

The function is a paid-for function, and a user pays for the function and obtains a license key as follows; 1234-5678-9123-5678-5678.

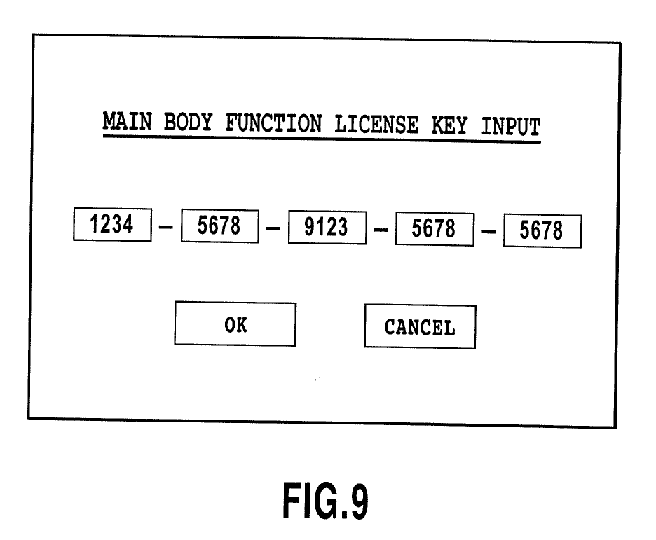

The document transmission function is validated by user's input of the license key from the user interface 124 (FIG. 9) of the image forming apparatus.

When the document transmission function has been validated by the license key input, the image forming apparatus is automatically set into a status in which the document transmission function can be used. The document transmission function does not have an ON/OFF setting in addition to the license key input.

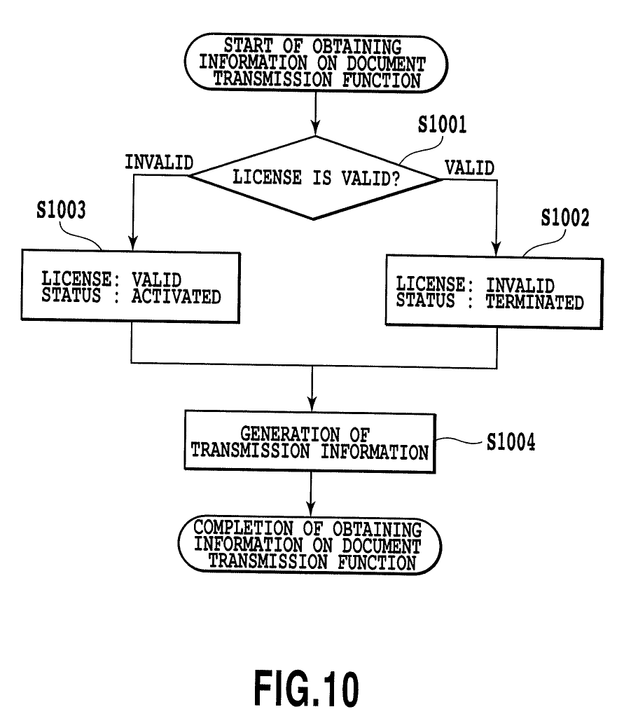

The obtaining operation of the document transmission function information will be explained in the following with reference to the flowchart of FIG. 10, as a detailed flow example for the operation of collecting the main body function information (S603). In the document transmission function information obtaining, the platform section 20 verifies whether the function has been validated or not by the license key input in the past (S1001). If the function has been validated, the platform section 20 obtains “validated” for the license status information and “activated” for the status (S1002). If the function has not been validated, the platform section 20 obtains “invalidated” for the license status information and “terminated” for the status (S1003). The platform section 20 generates transmission information (704) including information obtained according to the determination result of S1001, the main body function name, and the main body function ID (S1004).

### [Example of Obtaining Power Saving Mode Function Information]

The Power saving mode (705) function is assumed to have the following property.

The function is a charge-free function and can be used without particular operation of inputting the license key.

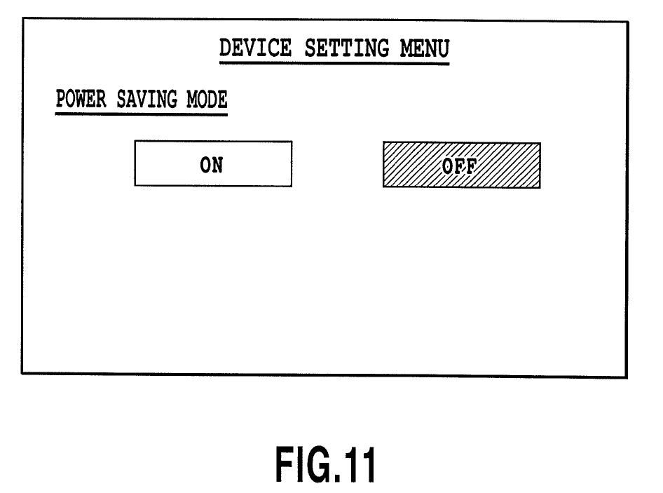

The power saving mode function has an ON/OFF setting of the function, and usually the ON/OFF setting can be switched on a device setting menu screen (FIG. 11), for example, displayed on the user interface 124 of the image forming apparatus.

When the function is ON, the image forming apparatus goes into the power saving mode in the case where the image forming apparatus has not been used for a certain time.

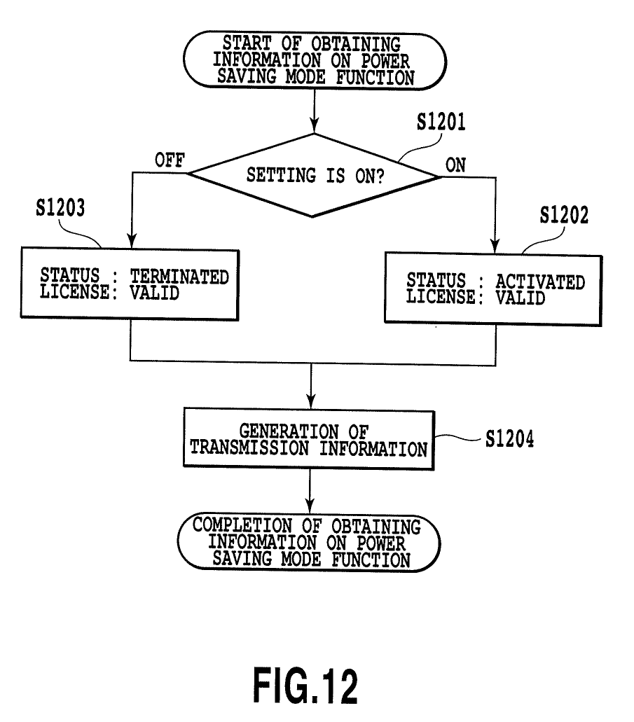

The obtaining operation of the power saving mode function information will be explained in the following with reference to the flowchart of FIG. 12, as a detailed flow example for the operation collecting the main body function information (S603). In the power saving mode function information obtaining, the platform section 20 verifies whether the power saving mode setting is ON or OFF (S1201). If the setting is ON, the platform section 20 obtains “activated” for the status information (S1202). If the setting is OFF, the platform section 20 obtains “terminated” for the status information (S1203). The platform section 20 obtains “validated” for the license status information regardless of ON/OFF of the setting because the license key is not necessary here. The platform section 20 generates transmission information (705) including information obtained according to the determination result of S1201, the main body function name, and the main body function ID (S1204).

### [Example of Obtaining Device Reactivation Function Information]

The Device reactivation (706) function is assumed to have the following property.

The function is free and can be used without particular operation of inputting the license key.

The function does not have an ON/OFF setting.

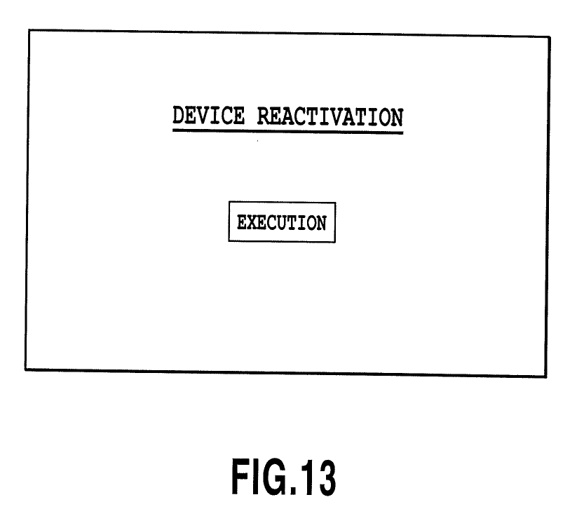

The device reactivation processing is usually started by execution of reactivation on the setting screen (e.g., FIG. 13) displayed on the display of the user interface 124 in the image forming apparatus.

The device reactivation function generates transmission information (706) including information that always the status is set to “terminated” and the license status is set to “validated”.

### [Example of Obtaining Department Management Function Information]

The department management function is assumed to have the following property.

The function is masked as a concealed function at the time of factory shipment.

The function is free and can be used without particular operation of inputting the license key.

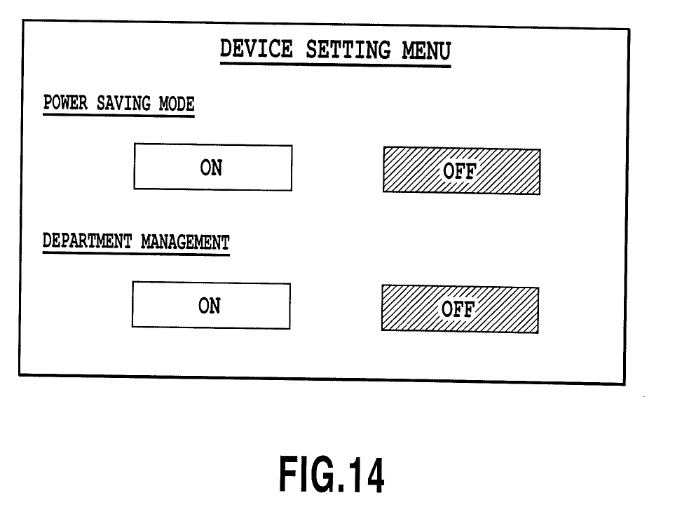

When the function is not masked, the function can set ON/OFF of the function on the setting screen (e.g., FIG. 14) displayed on the display of the user interface 124 in the image forming apparatus.

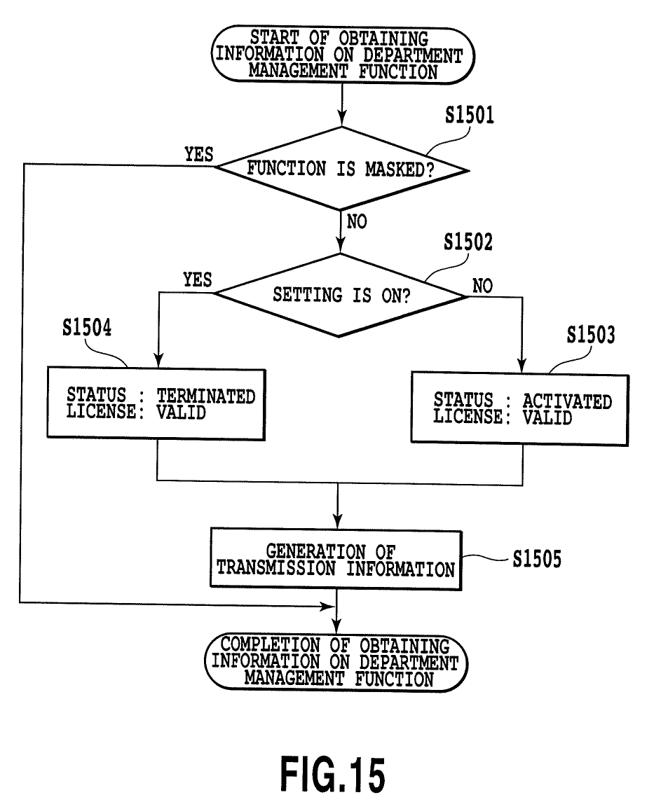

In the following, the operation of obtaining the department management function information will be explained with reference to the flowchart of FIG. 15, as an example of a detailed flow for the operation of collecting the main body function information (S603). In the obtaining of the department management function information, the platform section 20 verifies whether the department management function is masked or not (S1501). If the function is masked, the platform section 20 terminates the process without generating transmission information so as not to show the existence of the function to the outside. If the function is not masked, the platform section 20 subsequently verifies whether the setting of the department management function is ON or OFF (S1502). If the function is ON, the platform section 20 obtains “activated” for the status information (S1503). If the function is OFF, the platform section 20 obtains “terminated” for the status information (S1504). The platform section 20 obtains the “validated” license status information regardless of ON/OFF of the setting, because the license status is a function which needs not a license key. The platform section 20 generates transmission information including the information obtained according to the determination results, the main body function name, and the main body function ID (S1505).

[Explanation of Operation when an Application Install Request has been Received]

The image forming apparatus 1 can remove the mask of the masked main body function by receiving a dummy application file generated for the main body function, together with an install request from the management apparatus 200. The dummy application file 400 stores the main body function name in the application name 402, and stores the main body function ID in the application ID 403. The ID of the true application and the ID of the main body function are assumed not to overlap with each other. The application program 407 stores a dummy application program or is left vacant. The electronic signature 408 stores an electronic signature indicating that the application file is legitimate in the same way as in the true application file.

Note that the management apparatus 200 generates the dummy application file 400 by using the information such as the main body function ID input into the management apparatus 200 from a user, another apparatus, or the like (i.e., from the outside), and transmits the file to the image forming apparatus 1 together with the install request. Alternatively, the management apparatus 200 may transmit the dummy application file 400 provided from the vender of the image forming apparatus 1 to the image forming apparatus 1 together with the install request.

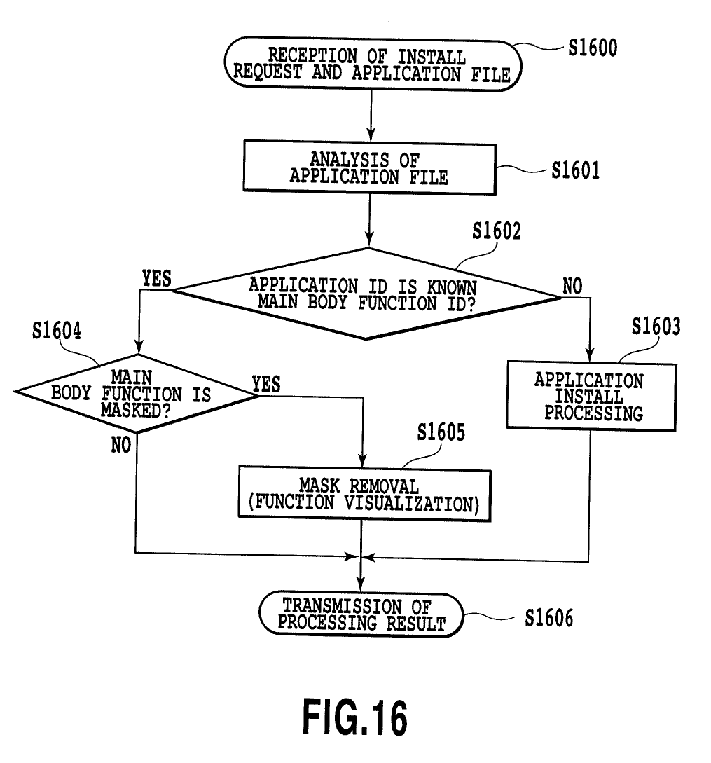

Operation when the image forming apparatus 1 has received the application file install request and the application file from the management apparatus 200 will be explained with reference to the flowchart of FIG. 16.

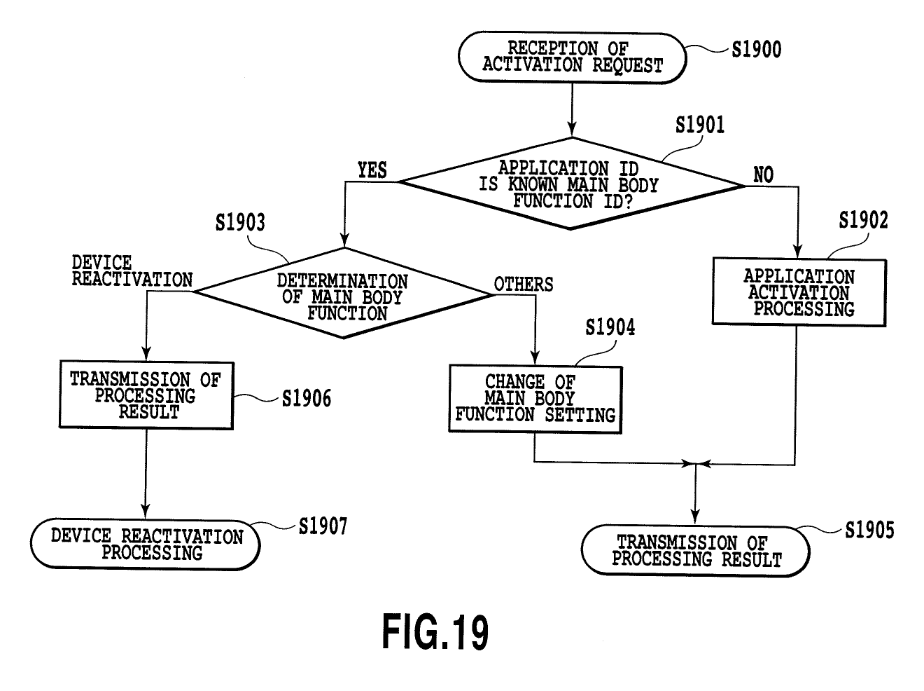

The platform section 20 starts the operation when having received the install request together with the application file transmitted from the management apparatus 200 via the external interface part 125 (software install request receiving) (S1600). The platform section 20 analyzes the received application file and obtains an ID from the application ID 403 (S1601). Next, the platform section 20 determines whether or not the obtained ID is the ID of the main body function provided to the image forming apparatus 1 (S1602). If the obtained ID is not the main body function ID, the platform section 20 determines that the ID is a usual application ID and installs an application corresponding to the ID (S1603). Here, the platform section 20 obtains the application program 407 from the application file and stores the application program 407 into the indirect storage part 123 together with information stored in another application file. In S1602, if the obtained ID is determined to be the main body function ID, the platform section 20 subsequently specifies the main body function associated with the main body function ID and verifies whether the main body function is masked or not (main body function specification) (S1604). If the function is masked, the platform section 20 carries out processing for visualizing the corresponding main body function (i.e., makes the function go into an operable state via the user interface 124) (S1605). For example, when the main body function associated with the main body function ID is the department management function, the platform section 20 changes the device setting menu to be displayed on the user interface 124 from a menu as shown in FIG. 11 to a menu as shown in FIG. 19. Finally, the platform section 20 transmits the processing result to the management apparatus 200 and terminates the process (S1606). The platform section 20 transmits information indicating success when the process has been terminated without a problem, and transmits information indicating failure when an error occurs in the middle of the process.

[Explanation of Operation when an Application Uninstall Request has been Received]

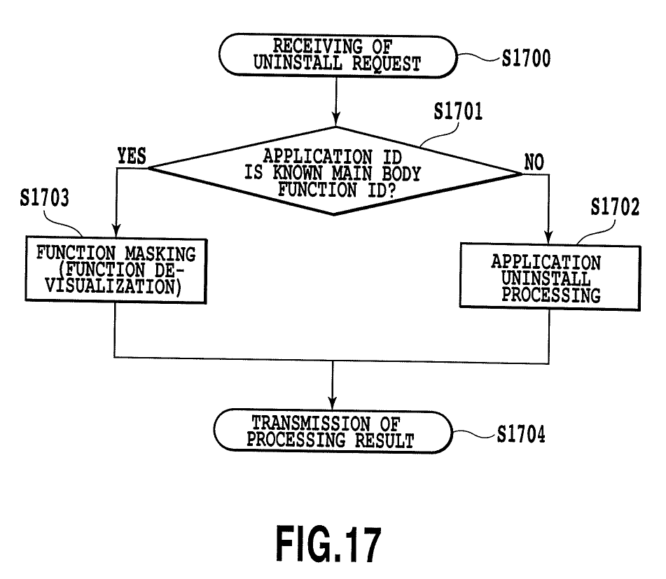

Operation when the image forming apparatus 1 has received an uninstall request from the management apparatus 200 will be explained with reference to the flowchart of FIG. 17. The platform section 20 starts the operation when having received the application ID and the uninstall request transmitted from the management apparatus 200 via the external interface part 125 (software uninstall request receiving) (S1700). Next, the platform section 20 determines whether or not the received application ID coincides with the main body function ID corresponding to any one of the main body functions provided to the image forming apparatus 1 (S1701). If both IDs does not coincide with each other, that is, the received ID is not the main body function ID, the platform section 20 carries out the uninstall processing of the usual application (S1702). Here, the platform section 20 deletes the application program associated with the application ID from the indirect storage part 123. In S1701, if the main body function is determined, the platform section 20 specifies the main body function associated with the main body function ID and masks (de-visualizes) the main body function (S1703). That is, the platform section 20 makes the function go into a status inoperable via the user interface part 124. For example, when the main body function associated with the main body function ID is the department management function, the platform section 20 changes the device setting menu to be displayed on the user interface 124 from a menu as shown in FIG. 14 to a menu as shown in FIG. 11. Finally, the platform section 20 transmits the processing result to the management apparatus 200 and terminates the process (S1704). The platform section 20 transmits information indicating success when the process has been terminated without a problem, and transmits information indicating failure when an error occurs in the middle of the process.

As explained above, in the processing shown in FIG. 16 to FIG. 17, the management apparatus 200 can unmask the main body function of the image forming apparatus 1 and can mask the main body function by transmitting the install or uninstall request of the application, respectively. That is, the management apparatus 200 can manage the function included in the image forming apparatus 1 even if it is not separately provided with a configuration for managing a function which is not the application function.

[Explanation of Operation when a License Install Request has been Received]

The image forming apparatus 1 can validate the main body function license by receiving the dummy license file 500 generated for the main body function, together with a software license install request from the management apparatus 200. The dummy license file 500 stores the main body function ID in the application ID 504. The license ID 502 stores a license key (e.g., 1234-5678-9123-5678-5678). The license key stored here is the same as the license key input into the license key input screen (FIG. 9) on the user interface part 124. The electronic signature 408 stores an electronic signature indicating that the license file is legitimate in the same way as the true application file stores the electronic signature.

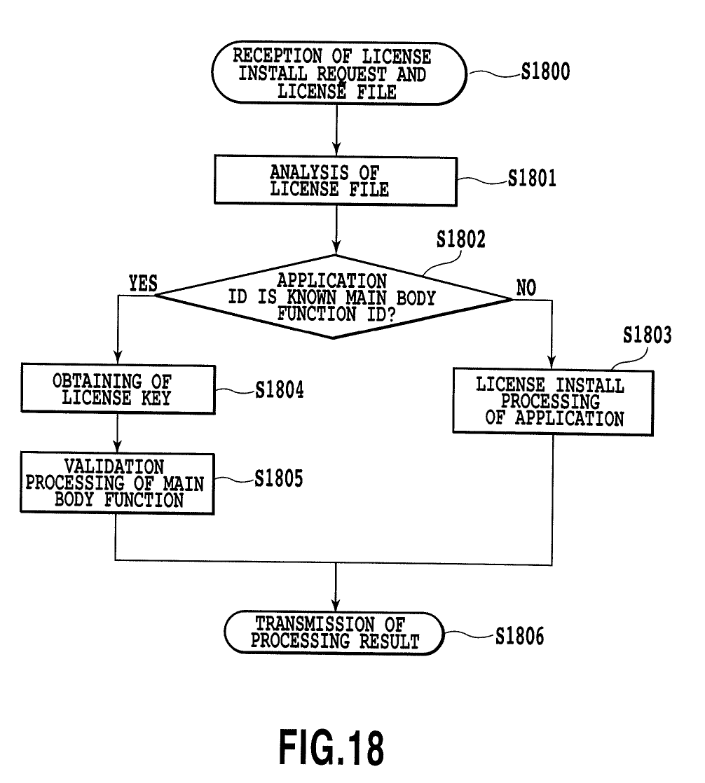

Operation when the image forming apparatus 1 has received the license install request will be explained with reference to the flowchart of FIG. 18.

The platform section 20 starts the operation when having received the license file 500 and the license install request transmitted from the management apparatus 200 via the external interface part 125 (license install request receiving) (S1800). Next, the platform section 20 analyzes the received license file 500 and obtains an ID from the area of the application ID 504 (S1801). Next, the platform section 20 determines whether or not the obtained ID is the main body function ID (S1802). If the obtained ID is not the main body function ID, the platform section 20 carries out processing for the license install of a usual application (S1803). Here, the platform section 20 associates the information obtained from the license file 500 with the application corresponding to the obtained ID and stores the information into the indirect storage part 123. In S1802, if the obtained ID is determined to be the main body function ID, the platform section 20 obtains the license key from the area of the license ID 502 in the license file 500 (S1804). Next, the platform section 20 carries out processing of validating the main body function associated with the obtained main body function ID (S1805) using the obtained license key. Finally, the platform section 20 transmits the processing result to the management apparatus 200 and terminates the process (S1806). The platform section 20 transmits information indicating success when the process has been terminated without a problem, and transmits information indicating failure when an error occurs in the middle of the process.

As explained above, in the processing shown in FIG. 18, the management apparatus 200 can install the license file of the main body function of the image forming apparatus 1 (S1804) and validate (set executability to) the main body function corresponding to the license file by transmitting the license install request. That is, the management apparatus 200 can manage the function included in the image forming apparatus 1 even if the management apparatus 200 is not separately provided with a configuration for managing a function which is not the application function.

[Explanation of Operation when an Application Activation Request has been Received]

Next, operation when the image forming apparatus 1 has received an application activation request together with the application ID will be explained with reference to the flowchart of FIG. 19. The platform section 20 starts the operation when having received the application ID and the application activation request transmitted from the management apparatus 200 via the external interface 125 (function activation request receiving) (S1900). Subsequently, the platform section 20 determines whether or not the received application ID coincides with any of the main body function IDs (S1901). If the received ID is not the main body function ID, the platform section 20 carries out activation processing of a usual application (S1902). Here, the platform section 20 moves (stores) the application program associated with the application ID from the indirect storage part 123 into the direct storage part 122. If the main body function is determined in S1901, the platform section 20 carries out determination of the main body function associated with the main body function ID (S1903). Next, the platform section 20 carries out change of the main body function setting (main body function reactivation) (S1904). For example, when the main body function associated with the main body function ID is the department management function, the platform section 20 changes the department management function from OFF to ON. The platform section 20 transmits the processing result to the management apparatus 200 and terminates the process (S1905). The platform section 20 transmits information indicating success when the process has been terminated without a problem, and transmits information indicating failure when an error occurs in the middle of the process. However, when carrying out the main body function for which the result cannot be transmitted quickly because the processing takes time, the platform section 20 transmits a dummy processing result in advance. For example, when the main body function associated with the main body function ID in S1903 is determined to be the device reactivation, the platform section 20 carries out the device reactivation processing (S1907) after having transmitted the processing result (S1906).

As explained above, in the processing shown in FIG. 19, the management apparatus 200 can activate the main body function of the image forming apparatus 1 by transmitting the application activation request (software function activation request) together with the information about the main body function such as the main body function ID (S1904 and S1907). That is, the management apparatus 200 can manage the function included in the image forming apparatus 1 even if the management apparatus 200 is not separately provided with a configuration for managing a function which is not the application function.

[Explanation of Operation when an Application Termination Request has been Received]

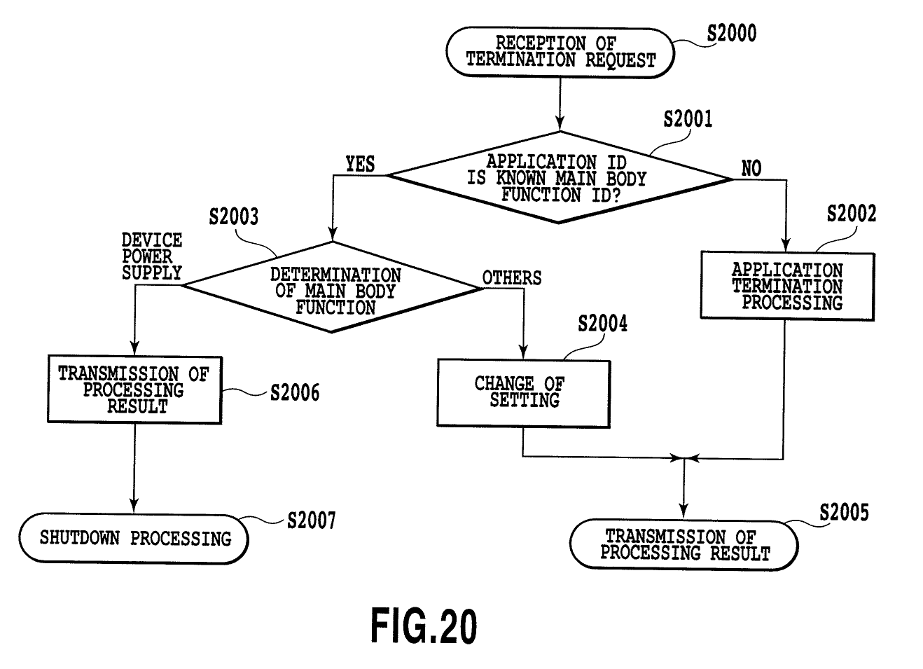

Next, operation when the image forming apparatus 1 has received an application termination request together with the application ID will be explained with reference to the flowchart of FIG. 20. The platform section 20 starts the operation when having received the application ID and the application termination request transmitted from the management apparatus 200 via the external interface 125 (S2000). Subsequently, the platform section 20 determines whether or not the received application ID coincides with any of the main body functions IDs (S2001). If the received function ID is not the main body function ID, the platform section 20 carries out termination processing of a usual application (S2002). If the main body function is determined in S2001 (main body function termination request receiving), the platform section 20 determines the main body function associated with the main body function ID (S1903). Next, the platform section 20 carries out change of main body function setting (main body function termination) (S2009). For example, when the main body function associated with the main body function ID is the department management function, the platform section 20 changes the department management function from OFF to ON (S2004). Further, the platform section 20 transmits the processing result to the management apparatus 200 and terminates the process (S2005). The platform section 20 transmits information indicating success when the process has been terminated without a problem, and transmits information indicating failure when an error occurs in the middle of the process. However, when carrying out the main body function for which the result cannot be transmitted after completion of the processing, the platform section 20 transmits a dummy processing result in advance. For example, when the main body function associated with the main body function ID in S2003 is determined to be the device power supply, the platform section 20 carries out the device power supply OFF processing (S2007) (shutdown processing) after having transmitted the processing result (S2006).

As explained above, in the processing shown in FIG. 20, the management apparatus 200 can terminate the main body function of the image forming apparatus 1 by transmitting the application termination request (software function termination request) together with the information about the main body function such as the main body function ID (S2004 and S2007). That is, the management apparatus 200 can manage the function included in the image forming apparatus 1 even if the management apparatus 200 is not separately provided with a configuration for managing a function which is not the application function.

### Second Embodiment

### Explanation of an Image Forming Apparatus

An image forming apparatus in the present embodiment is configured with an image processing device, a printer device, and a scanner device. An internal configuration of the image processing device is the same as that of FIG. 1. The platform section 20 of the present embodiment has a mechanism managing a job of printing or scanning which is in a status under execution or waiting for execution. The platform section 20 stores each of the various jobs into the direct storage part 122 and the indirect storage part 113 in association with the status as shown in the following.

Job Type: Information indicating a print job, a scan job, or the like

Job Name Name of a job

Job ID: Identifier for uniquely specifying a job

Job Status: Under execution/waiting for execution

The platform section 20 receives a job list obtaining request and a job cancel request transmitted from the outside via the external interface 125 and can execute job information transmission and job delete processing, respectively.

### [Explanation of a Network Configuration]

A network configuration in the present embodiment is the same as that in the embodiment 1 (FIG. 2). The management apparatus 200 in the present embodiment has a function of managing a job of the image forming apparatus.

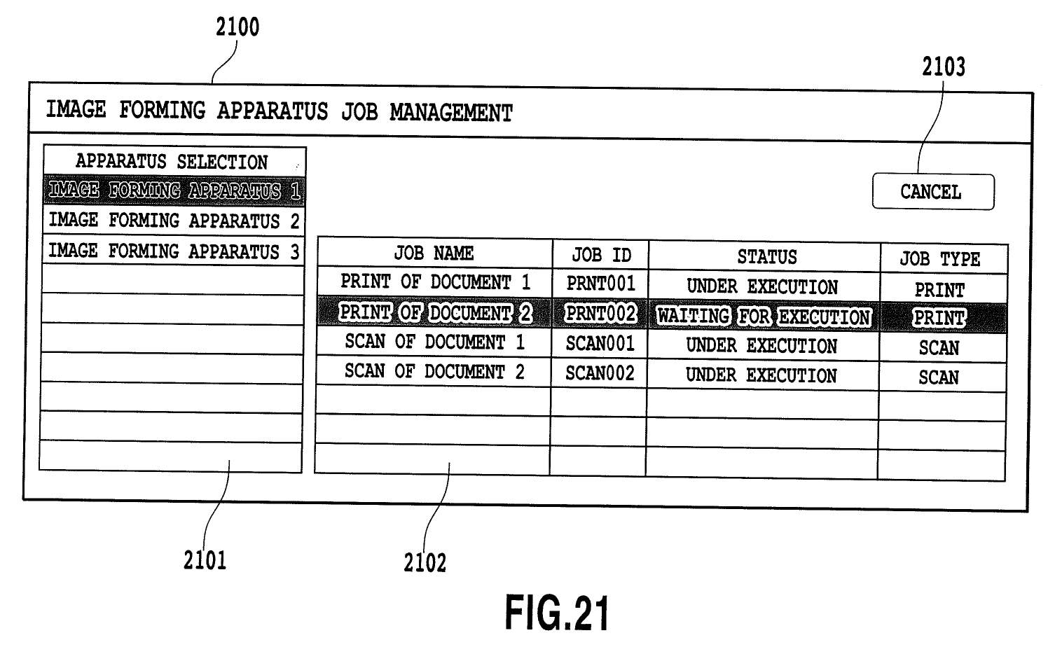

FIG. 21 is a diagram showing a UI screen displayed on the management apparatus 200 for managing the job of the image forming apparatus. On the job management screen 2100 of the image forming apparatus are arranged an image forming apparatus selection view 2101, a job information display view of the selected image forming apparatus 2102, and a job cancel button 2103. The job information display view 2102 displays a job name, an ID uniquely specifying the job, a job status, a job type, etc. The management apparatus 200 can transmit a request of obtaining the print job or scan job information list to the selected image forming apparatus. Further, when a user has selected a job in the job information display view 2102 and pushed down the cancel button 2103, the management apparatus 200 transmits a job cancel request to the selected image forming apparatus together with the job ID.

[Processing when a Job List Obtaining Request has been Received]

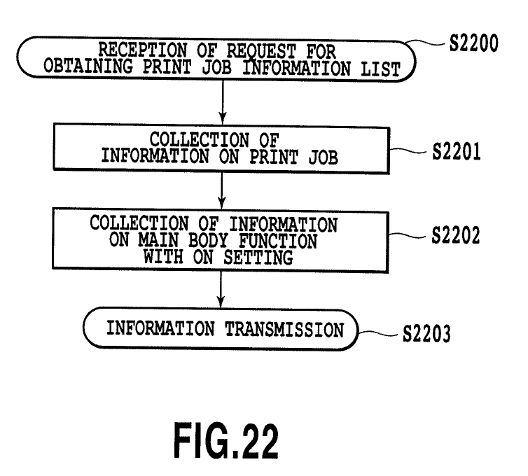

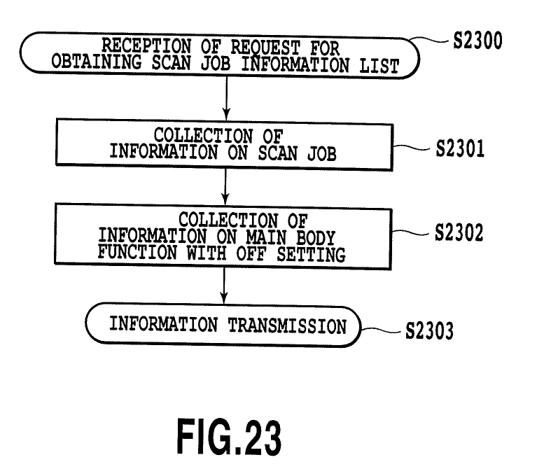

Next, the operation of the image forming apparatus 1 according to the present embodiment will be explained with reference to the flowcharts of FIG. 22 and FIG. 23. The platform section 20 starts the operation by having received a print job list (first job list) information obtaining request transmitted from the management apparatus 200 via the external interface 125 (S2200). Next, the platform section 20 collects print job information in the image forming apparatus 1 (S2201). Further, the platform section 20 collects information of the main body function which is set to ON or activated (S2202), and transmits the main body function information to the management apparatus 200 together with the print job information collected in S2201 (S2203). That is, the platform section 20 collects the information of the main body function which is set to ON or activated and transmits the information to the management apparatus 200, after having received the print job list information obtaining request.

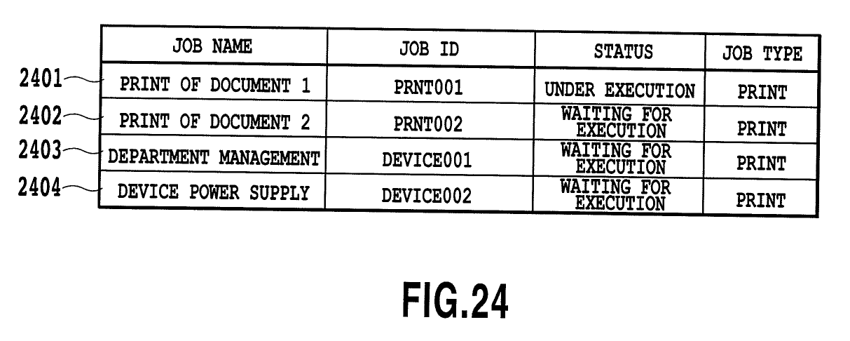

FIG. 24 shows an example of the information transmitted in S2203. For example, print of document 1 (2401) and print of document 2 (2402) are the print job information, and department management (2403) and device power supply (2409) are main body function information. The main body function information is set as follows.

Job Name: Function name of each main body function

Job ID: Main body function ID

Status: Waiting for execution

Job Type: Print

Next, the operation when the image forming apparatus 1 has received a scan job list information obtaining request will be explained. The platform section 20 starts the operation by receiving the scan job list (second job list) information obtaining request transmitted from the management apparatus 200 via the external interface 125 (S2300). Subsequently, the platform section 20 collects scan job information in the image forming apparatus 1 (S2301). Further, the platform section 20 collects information of the main body function which is set to OFF or terminated (S2302), and transmits the main body function information to the management apparatus 200 together with the scan job information collected in S2301 (S2303). That is, the platform section 20 collects the information of the main body function which is set to OFF or terminated and transmits the information to the management apparatus 200 after having received the scan job list information obtaining request.

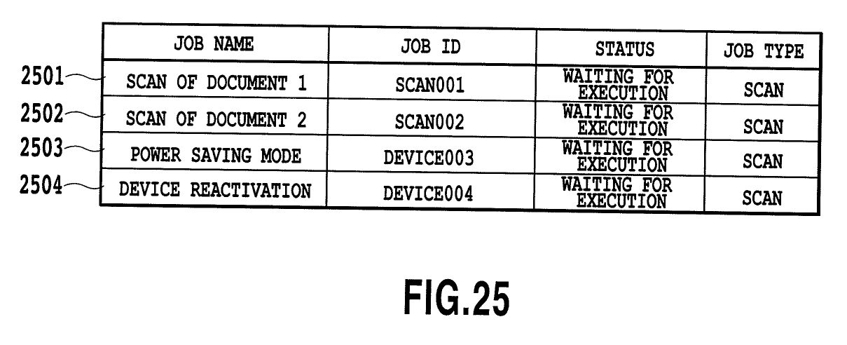

FIG. 25 shows an example of the information transmitted in S2303. For example, scan of document 1 (2501) and scan of document 2 (2502) are the scan job information, and power saving mode (2503) and device reactivation (2504) are the main body function information. The main body function information is set as follows.

Job Name: Function name of each main body function

Job ID: Main body function ID

Status: Waiting for execution

Job Type: Scan

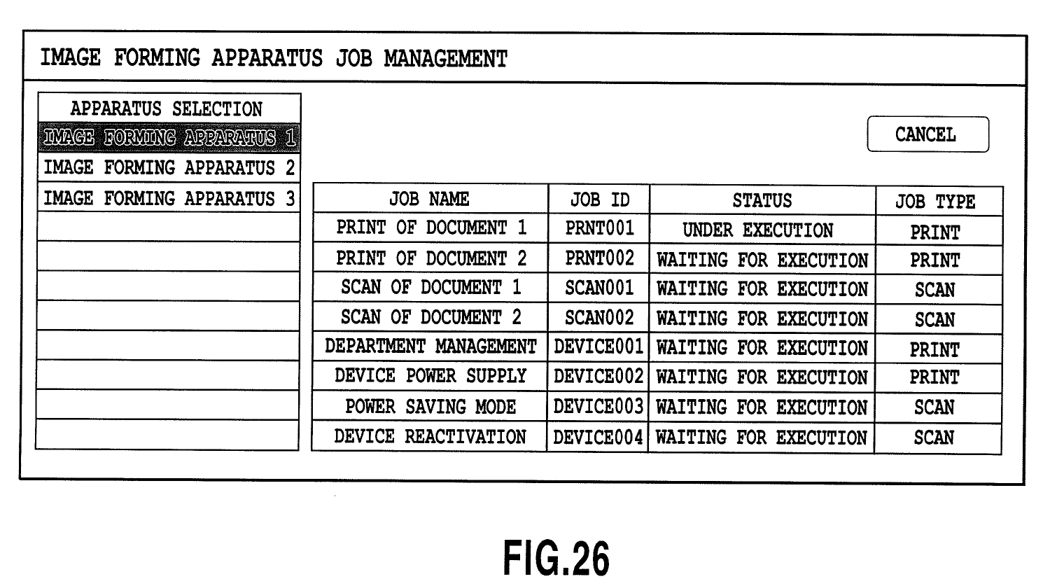

When having received the information as shown in FIG. 24 and FIG. 25 from the image forming apparatus 1, the management apparatus 200 displays the received information on the application information display view of the UI screen in the management apparatus (FIG. 26). In the application information display view shown in FIG. 26, “Job Type” is displayed as “print” for the main body function which is set to ON or activated. In addition, “Job Type” is displayed as “scan” for the main body function which is set to OFF or terminated.

Note that, the present embodiment associates the print job (first job) with the main body function which is set to ON or activated and associates the scan job (second job) with the main body function which is set to OFF or terminated. However, the association of the job type with the status of the main body function is not limited to this method and may be carried out by any method which can identify the status of the main body function.

As explained above, in the processing of FIG. 22 to FIG. 26, the image forming apparatus 1 collects the information of the main body function which is set to ON or activated and transmits the information to the management apparatus 200 after having received the print job (first job) list information obtaining request from the management apparatus 200. Further, the image forming apparatus 1 collects the information of the main body function which is set to OFF or terminated and transmits the information to the management apparatus 200, after having received a scan job (second job) list information obtaining request from the management apparatus. The management apparatus 200 displays the received job information by dividing the information into the first job and the second job. That is, the management apparatus 200 can manage the function included in the image forming apparatus 1 even if the management apparatus 200 is not provided separately with a configuration for managing a function which is not the application function.

[Processing when a First Job Cancel Request has been Received]

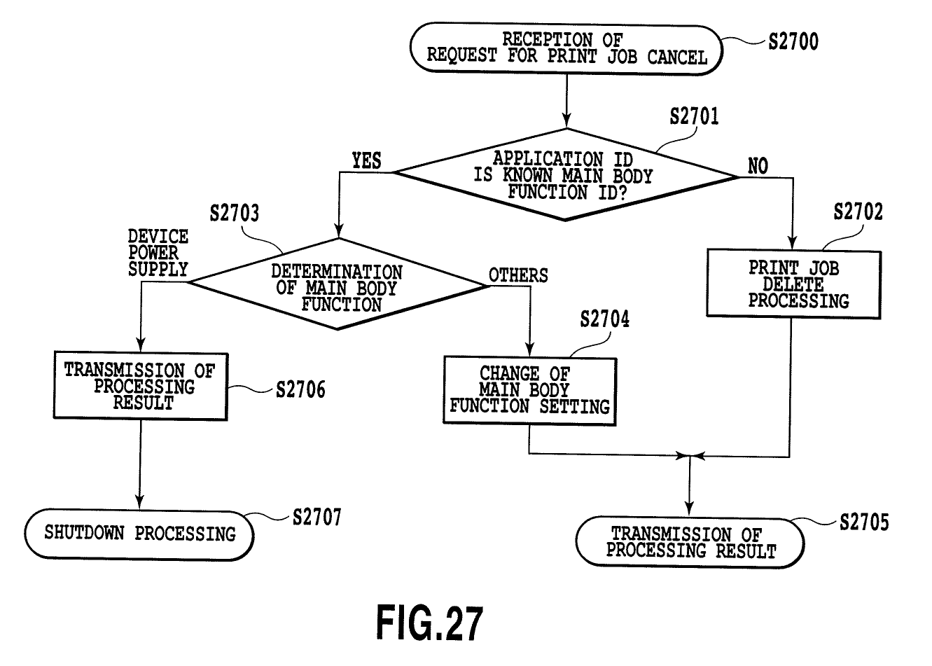

Next, the operation of the image forming apparatus 1 according to the present embodiment will be explained with reference to the flowchart of FIG. 27. The platform section 20 starts the operation when having received the job ID and an print job cancel request transmitted from the management apparatus 200 via the external interface 125 (S2700). Subsequently, the platform section 20 determines whether or not the received job ID coincides with any of the main body function IDs (S2701). If the received ID is not the main body function ID, the platform section 20 carries out delete processing of the print job associated with the job ID (S2702). If the main body function is determined in S2701, the platform section 20 carries out determination of the main body function associated with the main body function ID (S2703). Subsequently, the platform section 20 changes the main body function setting (S2704). For example, when the main body function associated with the main body function ID is the department management function, the platform section 20 changes the department management function from ON to OFF, or from an activated status to a terminated status. Further, the platform section 20 transmits the processing result to the management apparatus 200 and terminates the process (S2705). The platform section 20 transmits information indicating success when the process has been terminated without a problem, and transmits information indicating failure when an error occurs in the middle of the process. However, when carrying out the main body function for which the result cannot be transmitted after the completion of the processing, the platform section 20 transmits a dummy processing result in advance. For example, when the main body function associated with the main body function ID in S2703 is determined to be the device power supply, the platform section 20 carries out the device power supply OFF processing (S2707) (shutdown processing) after having transmitted the processing result (S2706).

For example, when the department management function is changed from ON to OFF by the above processing, the management apparatus 200 carries out the job list information obtaining again and thereby the Job Type of the department management function is changed from print to scan on the UI screen of the management apparatus 200.

[Processing when a Second Job Cancel Request has been Received]

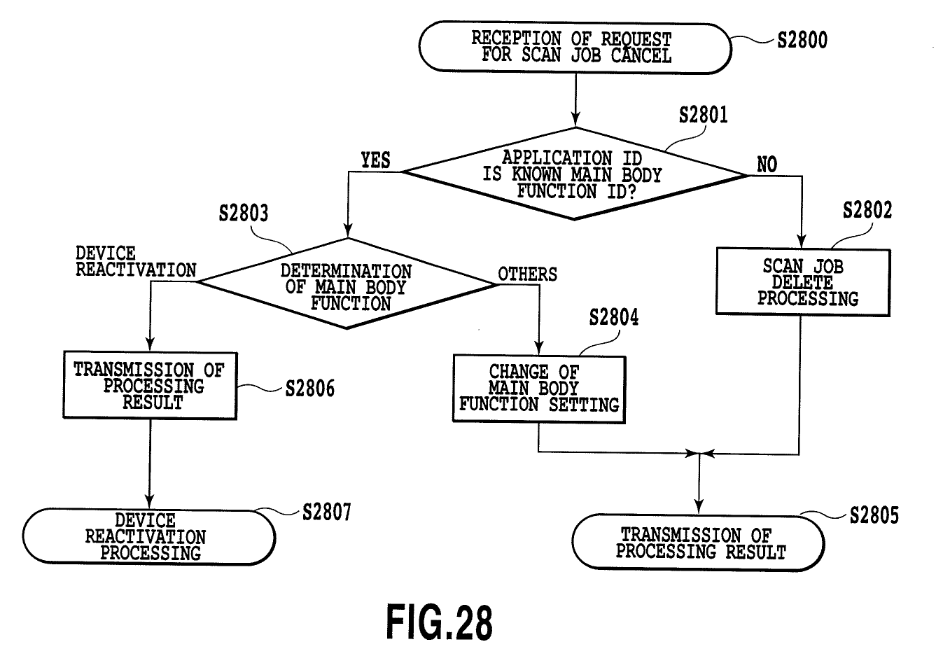

Next, the operation of the image forming apparatus according to the present embodiment will be explained with reference to the flowchart of FIG. 28. The platform section 20 starts the operation when having received the job ID and a scan job cancel request transmitted from the management apparatus 200 via the external interface part 125 (S2800). Subsequently, the platform section 20 determines whether or not the received job ID coincides with any of the main body function IDs (S2801). If the received ID is not the main body function ID, the platform section 20 carries out delete processing of the scan job associated with the job ID (S2802). If the main body function is determined in S2810, the platform section 20 determines the main body function associated with the main body function ID (S2803). Next, the platform section 20 changes the main body function setting (S2804). For example, when the main body function associated with the main body function ID is the power saving mode function, the platform section 20 changes the power saving mode from OFF to ON, or changes the department management function from a terminated state to an activated state (S2804). The platform section 20 transmits the processing result to the management apparatus 200 and terminates the process (S2805). The platform section 20 transmits information indicating success when the process has been terminated without a problem, and transmits information indicating failure when an error occurs in the middle of the process. However, when carrying out the main body function for which the result cannot be transmitted quickly because the processing takes time, the platform section 20 transmits a dummy processing result in advance. For example, when the main body function associated with the main body function ID in S2803 is determined to be the device reactivation, the platform section 20 carries out the device reactivation processing (S2807) after having transmitted the processing result (S2806).

For example, when the power saving mode function has been changed from OFF to ON by the above processing, the management apparatus 200 carries out the job list information obtaining again and thereby the job type of the power saving mode function is changed from scan to print on the UI screen of the management apparatus 200.

### Third Embodiment

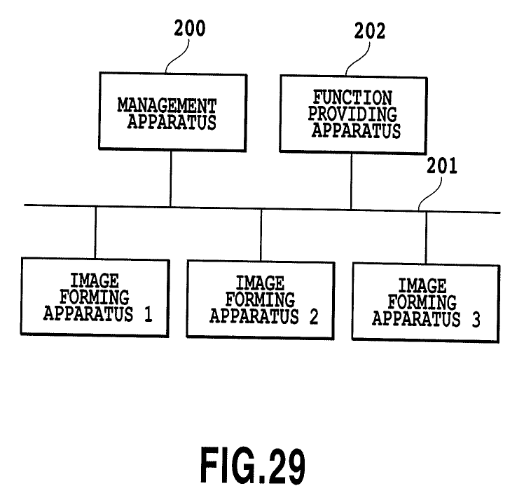

A configuration of an image forming apparatus in the present embodiment is the same as that of the embodiment 1. FIG. 29 shows a schematic diagram representing a network configuration in the present embodiment. The network configuration of the present embodiment includes a function providing apparatus 202 providing service to the image forming apparatus, in addition to the network configuration of the embodiment 1. The function providing apparatus 202 can be configured with a typical information processing apparatus such as a PC (Personal Computer). The function providing apparatus 202 communicates with the image forming apparatus and provides a function for a user utilizing the image forming apparatus. For example, a web browser provided in the platform section 20 of the image forming apparatus communicates with the function providing apparatus 202 via the external interface 125 in the HTTP protocol. Further, the image forming apparatus interprets data in the HTML format received from the function providing apparatus 202 and displays an operation screen on the user interface 124 of the image forming apparatus. In the following, the function provided by the function providing apparatus 202 is called an external function when viewed from the platform section 20 of the image forming apparatus. The platform section 20 can obtain the information of the external function via the external interface 125 in the same way as that of the main body function. In the configuration of the present embodiment, the platform section 20 collects the external function information and transmits the following information to the management apparatus, in the same way as for the main body function, when having received the application information obtaining request from the management apparatus.

Application name: Function name of each external function

Application ID: External function ID Status: Status matching the status of each external function

License: Status matching the license status of each external function

Further, the platform section 20 executes action for the external function when having received a request including the external function ID from the management apparatus.

### Other Embodiments

The present invention can be applied to a system configured with a plurality of devices (e.g., computer, interface device, reader, printer, etc.) and also to an apparatus configured with a single device (multifunction peripheral, printer, facsimile apparatus, etc.).

Aspects of the present invention can also be realized by a computer of a system or apparatus (or device such as a CPU or MP) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structure and functions.

This application claims the benefit of Japanese Patent Application No. 2008-322584, filed Dec. 18, 2008, which is hereby incorporated by reference herein in its entirety.

What is claimed is:

1. An apparatus that can communicate with other apparatus, the apparatus comprising:
a receiving unit receiving a request for obtaining information on a function included in the apparatus, from the other apparatus; and
a transmission unit transmitting information on a function different from the function related to the request for obtaining, to the other apparatus in response to the receiving of the request for obtaining by the receiving unit.

2. An apparatus that can communicate with a management apparatus, the apparatus comprising:
a receiving unit receiving a request for obtaining information on a function of software installed in the apparatus, from the management apparatus; and
a transmission unit transmitting information on a main body function to the management apparatus in response to the receiving of the request for obtaining by the receiving unit, the main body function being a different function from the software function related to the request for obtaining and being a function of the apparatus which is not installed or uninstalled after shipment of the apparatus.

3. The apparatus according to claim 2, wherein
the information on the main body function includes information indicating whether the main body function is validated or not.

4. The apparatus according to claim 2, further comprising:
a software install request receiving unit receiving a request for software install from the management apparatus together with a software format file including the information on the main body function;
a main body function specifying unit specifying the main body function corresponding to the information on the main body function received by the software install request receiving unit;
a user interface; and
a visualization unit setting the main body function specified by the main body function specifying unit to have a status in which the main body function can be operated via the user interface.

5. The apparatus according to claim 2, further comprising:
a software uninstall request receiving unit receiving a request for software uninstall from the management apparatus together with the information on the main body function;
a main body function specifying unit specifying the main body function corresponding to the information on the main body function received by the software uninstall request receiving unit;
a user interface; and
a devisualization unit setting the main body function specified by the main body function specifying unit to have a status in which the main body function cannot be operated via the user interface.

6. The apparatus according to claim 2, further comprising:
a license install request receiving unit receiving a request for installation of a software license from the management apparatus together with a license format file including the information on the main body function;
a main body function specifying unit specifying the main body function corresponding to the information on the main body function received by the license install request receiving unit; and
an enabling executable unit setting the main body function specified by the main body function specifying unit to be executable.

7. The apparatus according to claim 2, further comprising:
a function activation request receiving unit receiving a request for activating a software function from the management apparatus together with the information on the main body function;
a main body function specifying unit specifying the main body function corresponding to the information on the main body function received by the function activation request receiving unit; and
a main body function activation unit activating the main body function specified by the main body function specifying unit.

8. The apparatus according to claim 2, further comprising:
a function termination request receiving unit receiving a request for terminating a software function from the management apparatus together with the information on the main body function;
a main body function specifying unit specifying the main body function corresponding to the information on the main body function received by the function termination request receiving unit; and
a main body function termination unit terminating the main body function specified by the main body function specifying unit.

9. An apparatus of which a job is managed by a management apparatus, comprising:
a receiving unit receiving a request for obtaining a job information list of the apparatus from the management apparatus; and
a transmission unit transmitting information on a function which is not the job but a function included in the apparatus, to the management apparatus in response to the receiving of the request for obtaining by the receiving unit.

10. An apparatus of which a job is managed by a management apparatus, comprising:
a unit receiving a request for obtaining a first job list;
a unit transmitting information on an activated main body function among the main body functions to the management apparatus in response to the received request for obtaining the first job list, the main body functions being functions of the apparatus which are not installed or uninstalled after shipment of the apparatus;
a unit receiving a request for obtaining a second job list; and
a unit transmitting information on the terminated main body function among the main body functions to the management apparatus in response to the received request for obtaining the second job list.

11. The apparatus according to claim 10, further comprising:
a unit receiving a request for canceling the first job from the management apparatus together with the information on the main body function; and
a unit terminating the activated main body function corresponding to the received information on the main body function.

12. The apparatus according to claim 10, further comprising:
a unit receiving a request for canceling the second job from the management apparatus together with the information on the main body function; and
a unit activating the terminated main body function corresponding to the received information on the main body function.

13. The apparatus according to claim 2, wherein
the apparatus can communicate with a function providing apparatus providing an external function which is a function executable by the apparatus, and
the main body function includes the external function.

14. A method performed in an apparatus that can communicate with a management apparatus, the method comprising:
receiving a request for obtaining information on a software function installed in the apparatus, from the management apparatus; and
transmitting information on a main body function to the management apparatus in response to the receiving of the request for obtaining by the receiving step, the main body function being a function different from the software function related with the request for obtaining and being a function of the apparatus which is not installed or uninstalled after shipment of the apparatus.

15. A computer-readable recording medium having computer-executable instructions for performing the method of claim 14.
